(19) United States
(12) Patent Application Publication
(10) Pub. No.: US 2002/0059695 A1
(43) Pub. Date: May 23, 2002

(54) High precision operating knob

(76) Inventor: Guo Liang Yang, Kun-Shan (CN)

Correspondence Address: Wei Te (Joseph) Chung, Foxconn International, Inc., 1650 Memorex Drive, Santa Clara, CA, 95050, US

(21) Appl. No.: 09/795,861

(22) Filed: Feb. 27, 2001

(30) Foreign Application Priority Data
Nov. 17, 2000 (TW) 89219990

(51) Int. Cl. E05B 1/00

(52) U.S. Cl. 16/441

(57) ABSTRACT

An operating knob (1) includes an upper knob portion (11), a lower knob portion (12), and a neck portion (13) connecting the upper knob portion with the lower knob portion. The upper knob portion is hexagonal in shape and defines a first recess (111) in each of six side edges (112) thereof. The lower knob portion defines a plurality of second recesses (122) in a side edge (124) thereof. A screw hole (14) is axially defined through the lower knob portion into the upper knob portion. The number of second recesses is greater than the number of first recesses. When turning the knob, two to four fingers (21, 22) of the user rotate the upper knob portion in a clockwise or anti-clockwise direction and a thumb (23) of the user pushes the side edge of the lower knob portion in the clockwise or anti-clockwise direction.

### BACKGROUND OF THE INVENTION

1. Field of the Invention

The present invention relates to an operating knob, and particularly to a high precision operating knob having a screw therein/thereon, the knob being suitable for a user to rotate.

2. Description of the Related Art

In the prior art, an operating knob used to adjust the setting of test and measuring equipment or machines is usually a simple knob mounted on a rod. This type of operating knob is often hexagonal in shape. Such a knob defines six recesses in side edges thereof, each recess corresponding to a side of a hexagon, for permitting the fingers, including the thumb, of a user to rotate the knob. When using this type of knob to make fine accuracy adjustments, the thumb must be parallel to the other four fingers. This orientation of the thumb and finger is tiring and makes precise movement of the knob difficult.

Hence, an improved operating knob is required to overcome the disadvantages of the prior art.

### BRIEF SUMMARY OF THE INVENTION

A main object of the present invention is to provide a high-precision operating knob suitable for a user to handle when adjusting a machine setting with precision.

An operating knob comprises an upper knob portion, a lower knob portion, and a neck portion connecting the upper knob portion with the lower knob portion. The upper knob portion is hexagonal in shape and defines six first recesses in side edges thereof. The lower knob portion defines a plurality of second recesses in a side edge thereof. A screw hole is defined axially through the operating knob, penetrating through the lower knob portion and into the upper knob portion. The knob is mounted in a position on a place of equipment or a machine such that the axis of the screw hole is substantially perpendicular to the user's forearm. To use the high-precision operating knob, two to four of the user's fingers are engaged with the first recesses of the upper knob portion, and the thumb is pressed against the side edge of the lower knob portion. When turning the knob, the two to four fingers of the user rotate the upper knob portion in a clockwise or anti-clockwise direction and the thumb pushes the side edge of the lower knob portion in the clockwise or anti-clockwise direction. During this rotation movement, the user's fingers are substantially perpendicular to the user's thumb.

Other objects, advantages and novel features of the invention will become more apparent from the following detailed descriptionof the present embodiment when taken in conjunction with the accompanying drawings.

### BRIEF DESCRIPTION OF THE DRAWINGS

FIG. 1 is a perspective view of a knob in accordance with a first embodiment of the present invention;

FIG. 2 is a side view of the knob of FIG. 1;

FIG. 3 is a bottom view of the knob of FIG. 1;

FIG. 4 is a side view of the knob of FIG. 1 with a user's hand operating the knob; and

FIG. 5 is a perspective view of a knob in accordance with a second embodiment of the present invention.

### DETAILED DESCRIPTION OF THE INVENTION

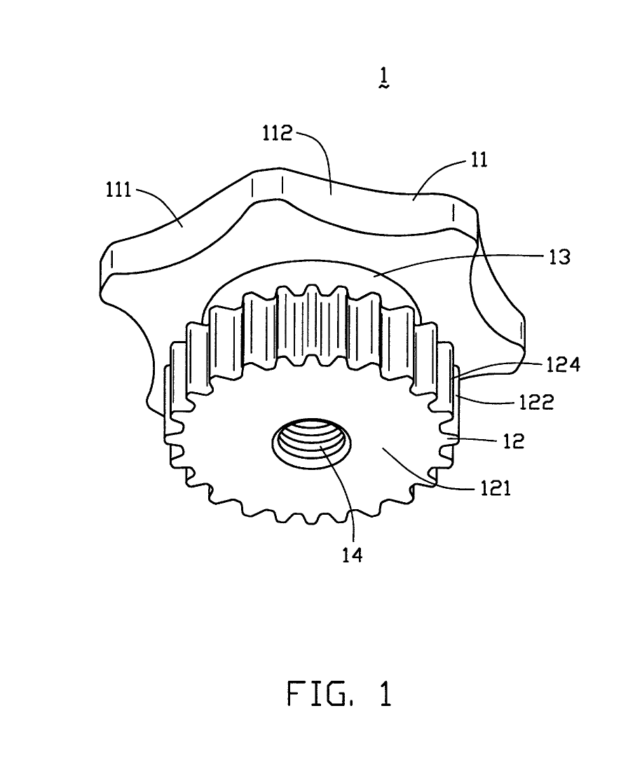

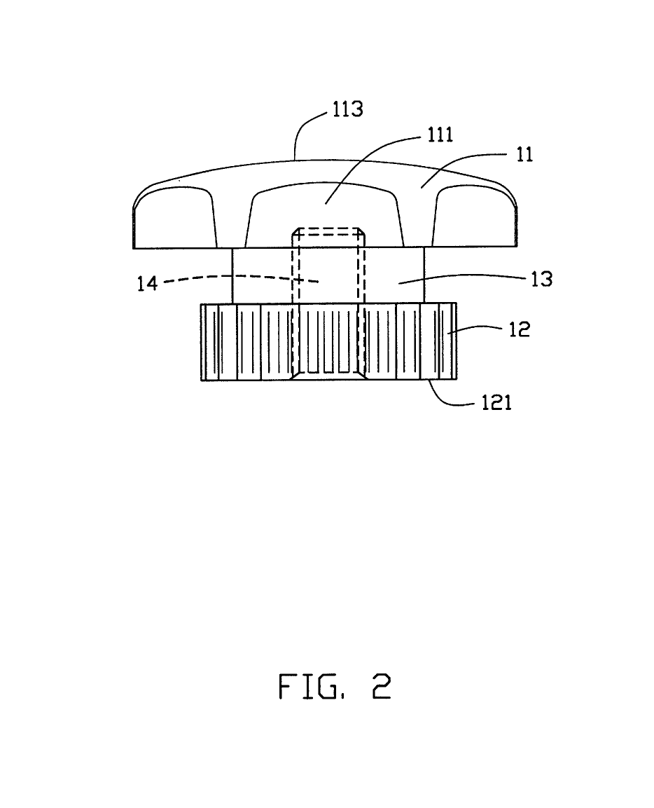

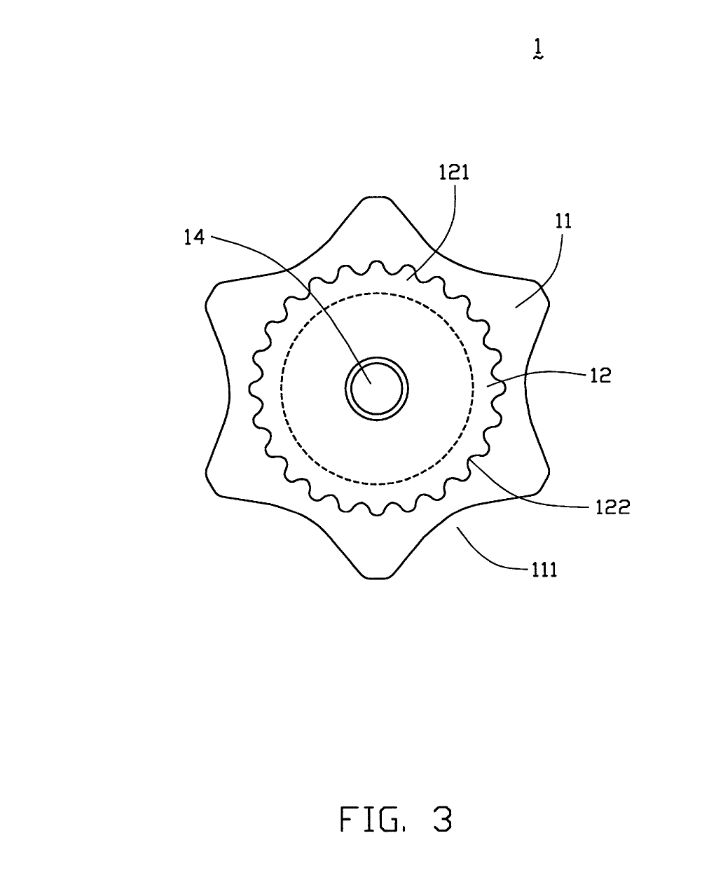

Referring to FIGS. 1-3, a high-precision operating knob 1 for mounting on testing or measurement equipment comprises an upper/outer knob portion 11 , a lower/inner knob portion 12, and a neck portion 13 integrally connecting the upper knob portion 11 with the lower knob portion 12.

The upper knob portion 11 is hexagonal in shape and defines a first recess 111 in each of six side edges 112 thereof. The upper knob portion 11 has an arcuate top face 113 suitable for fitting the palm of a user's hand. The upper knob portion 11 has a first radius (not labeled).

The lower knob portion 12 is approximately cylindrical in shape and has a common axis of rotation and symmetry with the upper knob portion 11. The lower knob portion 12 defines a plurality of second recesses 122 in a side edge 124 thereof. The lower knob portion 12 has a second radius (not labeled). The second radius of the lower knob portion 12 is shorter than the first radius of the upper knob portion 11.

A screw hole 14 is defined axially through the operating knob 1 from a bottom face 121 of the lower knob portion 12 and penetrating through the lower knob portion 12 to the upper knob portion 11.

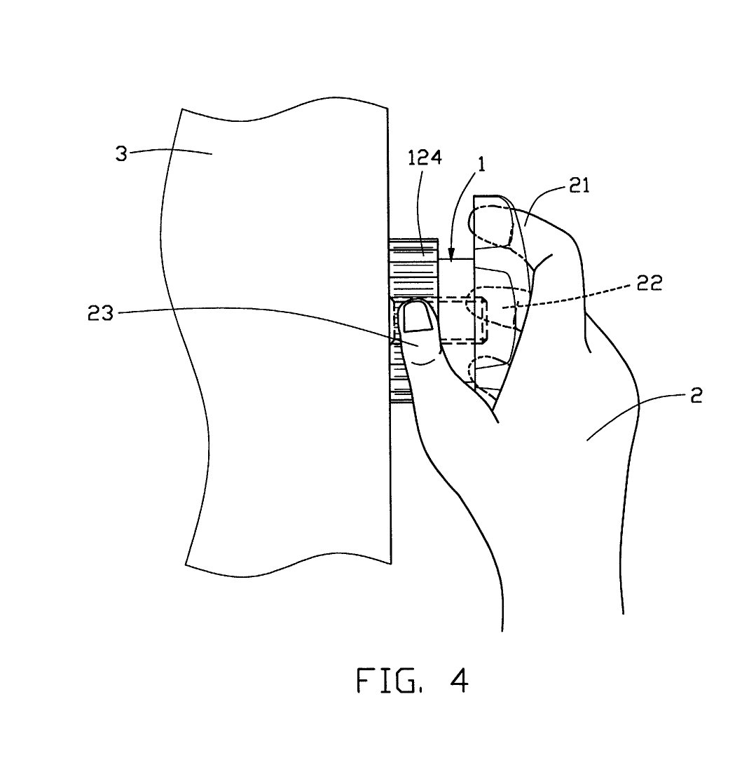

Referring to FIG. 4, the knob 1 is mounted on a piece of equipment 3 such that the axis of the screw hole 14 is substantially perpendicular to the user's fore arm 2. To use the high-precision operating knob 1, two to four of the user's fingers 21, 22 are engaged with the first recesses 111 of the upper knob portion 11, and the thumb 23 is pressed against the side edge 124 of the lower knob portion 12. When turning the knob 1, the two to four fingers 21, 22 of the user rotate the upper knob portion 11 in a clockwise or anti-clockwise direction and the thumb pushes the side edge 124 of the lower knob portion 12 in the clockwise or anti-clockwise direction. During this rotating movement, the user's fingers 21, 22 are substantially perpendicular to the user's thumb 23.

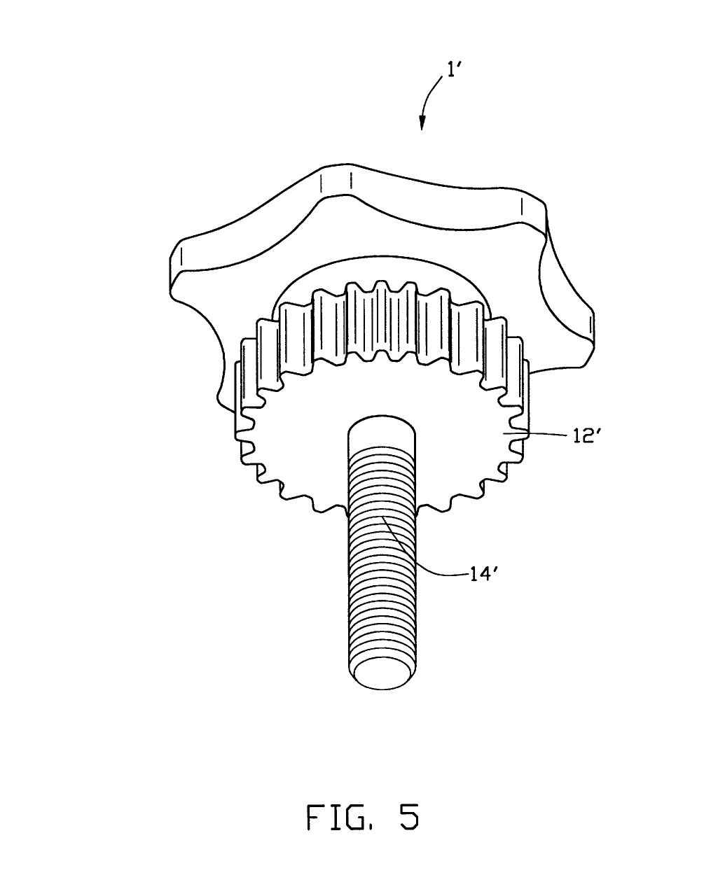

Referring to FIG. 5, a knob 1′ of the second embodiment of the present invention is similar to the knob 1 of the first embodiment of the present invention except for replacing the screw hole 14 with a screw post 14′. The screw post 14′ extends from a lower knob portion 12′.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An operating knob used to adjust the setting of test and measuring equipment or machines and mounted with its axis of rotation perpendicular to a user's arm, comprising:
an upper knob portion being polygonal in shape and defining a first recess in each of a plurality of side edges thereof, two to four fingers of the user being engageable with the first recesses of the upper knob portion, the upper knob portion having a first radius;
a lower knob portion defining a plurality of second recesses in a side edge thereof, the thumb of the user being pressed against the side edge of the lower knob portion, the lower knob portion having a second radius shorter than the first radius, the lower knob portion having a common axis of rotation and symmetry with the upper knob portion; and
wherein the number of the second recesses of the second knob portion is more than the number of the first recesses of the first knob portion.

2. The operating knob as claimed in claim 1, wherein a neck portion integrally connects the upper knob portion with the lower knob portion.

3. The operating knob as claimed in claim 2, wherein a screw hole is defined axially through the operating knob along the axis of rotation and symmetry, penetrating through the lower knob portion and into the upper knob portion.

4. The operating knob as claimed in claim 2, wherein a screw post extends axially along the axis of rotation and symmetry from the lower knob portion.

5. The operating knob as claimed in claim 1, wherein the upper knob portion has an arcuate top face suitable for fitting the palm of the user's hand.

6. The operating knob as claimed in claim 1, wherein the upper knob portion is hexagonal in shape and defines a first recess in each of six side edges thereof.

7. An operating knob rotatably about an axis, comprising:
an outer portion with a first radial dimension forming a first grasping area, along a periphery thereof, adapted to be used with a thumb; and
an inner portion with a second radial dimension forming a second grasping area, along a periphery thereof, adapted to be used with fingers except the thumb; wherein
said first radial dimension is larger than said second radial dimension.

8. The operating knob as claimed in claim 7, wherein said outer portion defines a first axial dimension along said axis, and said inner portion defines along said axis a second axial dimension larger than said first axial dimension.

9. The operating knob as claimed in claim 7, wherein said first grasping area includes a series of first recesses and said second grasping area includes a series of second recesses much denser than said first recesses.

10. A method of rotating an axis extending from a device, comprising steps of:
providing a operating knob with an end fastened to said axis;
forming a larger outer portion on the knob with a first grasping area on a periphery thereof;
forming a smaller inner portion on the knob, closer to the device than the outer portion, with a second grasping area on a periphery thereof;
applying a thumb of one hand unto the first grasping area and a plurality of fingers of said hand unto the second grasping area to exert a force together for rotating said knob.

11. The method as claimed in claim 10, wherein said thumb is positioned under said outer portion.
